(19) United States
(12) Patent Application Publication
(10) Pub. No.: US 2015/0062315 A1
(43) Pub. Date: Mar. 5, 2015

(54) SIMULTANEOUS 2D AND 3D IMAGES ON A DISPLAY

(71) Applicant: The Regents of the University of California, Oakland, CA (US)

(72) Inventors: James E. Davis, Santa Cruz, CA (US); Steven Scher, Chula Vista, CA (US); Jing Liu, Mountain View, CA (US); Rajan Vaish, Mountain View, CA (US); Prabath Gunawardane, Mountain View, CA (US)

(73) Assignee: THE REGENTS OF THE UNIVERSITY OF CALIFORNIA, Oakland, CA (US)

(21) Appl. No.: 14/395,418

(22) PCT Filed: Mar. 18, 2013
(86) PCT No.: PCT/US2013/032821

§ 371 Date: Oct. 17, 2014

Related U.S. Application Data
(60) Provisional application No. 61/635,075, filed on Apr. 18, 2012.

(51) Int. Cl. H04N 13/04

(52) U.S. Cl. CPC H04N 13/0429; H04N 13/0456
USPC 348/56

(57) ABSTRACT

Many 3D displays show 3D images to viewers wearing special eyeglasses, while showing a double image to viewers without eyeglasses (13e). We demonstrate a method (15a-15h) that provides those with eyeglasses a 3D experience while viewers without eyeglasses see a 2D image without artifacts (FIG. 1, image 1b). In addition to separate Left (“L”) and Right (“R”) images in each frame, we add a third image (“N”), invisible to those with glasses. In the combined view seen by those without glasses, this cancels the Right image, leaving only the Left. If the Left and Right images are of equal brightness, this approach results in low contrast to viewers without glasses. Allowing differential brightness between the Left and Right images improves 2D contrast. We determine that viewers with glasses maintain a strong 3D experience, even when one eye is significantly darker than the other.

### CROSS REFERENCE

This application claims the benefit of U.S. Provisional Application No. 61/635,075, filed on Apr. 18, 2012, the content of which is hereby incorporated by reference in its entirety.

### TECHNICAL FIELD

The disclosed subject matter relates generally to three-dimensional television (3DTV) technology, and more particularly to a method and system that provide viewers with 3D glasses a 3D experience while viewers without glasses see a 2D image without artifacts such as ghosting. Our approach is applicable to displays using either active-shutter glasses or passive glasses.

### BACKGROUND

With a 3DTV, depth perception is conveyed to the viewer by employing techniques such as stereoscopic display, multi-view display, 2D-plus-depth, or any other form of 3D display. Most modern 3D television sets use an active shutter 3D system or a polarized 3D system and some are autostereoscopic without the need of glasses.

There are several techniques to produce and display 3D moving pictures. A basic requirement for display technologies is to display offset images that are filtered separately to the left and right eye. Two approached have been used to accomplish this: (1) have the viewer wear 3D eyeglasses to filter the separately offset images to each eye, or (2) have the light source split the images directionally into the viewer's eyes, with no 3D glasses required.

As explained in the detailed description below, many 3D displays show 3D images to viewers wearing the special 3D eyeglasses, but show an incomprehensible double image (called “ghosting”) to viewers without glasses. A goal of the present invention is to devise a method and system for providing viewers with glasses a 3D experience while also providing viewers without glasses a 2D image without artifacts.

### SUMMARY

Many 3D displays show 3D images to viewers wearing special eyeglasses, while showing an incomprehensible double image to viewers without glasses. We demonstrate a method that provides those with eyeglasses a 3D experience while viewers without glasses see a 2D image without artifacts. In addition to separate Left and Right images in each frame, we add a third image, invisible to those with glasses. In the combined view seen by those without glasses, this cancels the Right image, leaving only the Left. If the Left and Right images are of equal brightness, this approach results in low contrast to viewers without glasses. Allowing differential brightness between the Left and Right images improves 2D contrast. We determine that viewers with glasses maintain a strong 3D experience, even when one eye is significantly darker than the other. Since viewers with glasses see a darker image in one eye, they experience a small distortion of perceived depths due to the Pulfrich Effect. This produces illusions similar to those caused by a time delay in one eye. We find that a 40% brightness difference cancels an opposing distortion caused by the typical 8 millisecond delay between the Left and Right images of sequential active-shutter stereoscopic displays. Our technique is applicable to displays using either active-shutter glasses or passive glasses.

Other aspects of the inventive method and system are described below.

### BRIEF DESCRIPTION OF THE DRAWINGS

FIG. 1, part (a), depicts how a typical glasses-based 3DTV shows a different image to each eye of viewers wearing stereo glasses. Part (b) depicts how an inventive 3D+2DTV shows a different image to each eye of viewers wearing stereo glasses, but shows only one of these images to those without glasses, removing the “ghosted” double-image. Part (c) illustrates that this is accomplished by cancelling out one image of the stereo pair.

FIG. 2 depicts a comparison of various displays that show a sequence of frames.

FIG. 3 illustrates how different amounts of wasted light result from different frame lengths for the L, R and inverse R frames.

FIG. 4 is a graph showing how max2D, the brightness of the composite image seen by viewers not wearing stereo glasses, improves when aR, the brightness of the image shown to the right eye of 3D viewers, is decreased.

FIG. 5 depicts two versions of an image: (left) the ghosted double-image that would be seen on a typical 3D display if the viewer did not wear stereo glasses, and (right) the lower-contrast image without ghosting that the viewer would see on a display in accordance with the present invention.

FIG. 6 is a graph of viewer preference data.

FIG. 7 depicts images used in an experiment to quantify viewers' ability to perceive depth in static images on a stereoscopic display when one eye is presented with a darker image than the other eye.

FIG. 8 is a graph of the results of the experiment of FIG. 7, showing that as one eye's brightness decreases, viewers' ability to perceive depth is not affected until the brightness of the darker eye is below 20% of the brightness of the brighter eye.

FIG. 9 depicts images used in an experiment to measure viewers' ability to perceive depth when the images shown to one eye are darker than those shown to the other eye.

FIG. 10 is a graph of data from the experiment of FIG. 9, showing that viewers' ability to perceive depth differences was undisturbed by one eye seeing a darker image than the other provided the dark image was at least 10% as bright as the brighter eye.

FIG. 11 depicts images used in an experiment to quantify the impact of the Pulfrich Effect on depth perception.

FIG. 12 is made up of two graphs of data showing that, when one eye is brighter than the other, the depth of moving objects is misperceived.

FIG. 13 depicts a prototype of the inventive system including two projectors and a polarization preserving screen.

FIG. 14 depicts several example images of the inventive prototype in use.

FIG. 15 is a block diagram of a system in accordance with the present invention.

### DETAILED DESCRIPTION OF ILLUSTRATIVE EMBODIMENTS

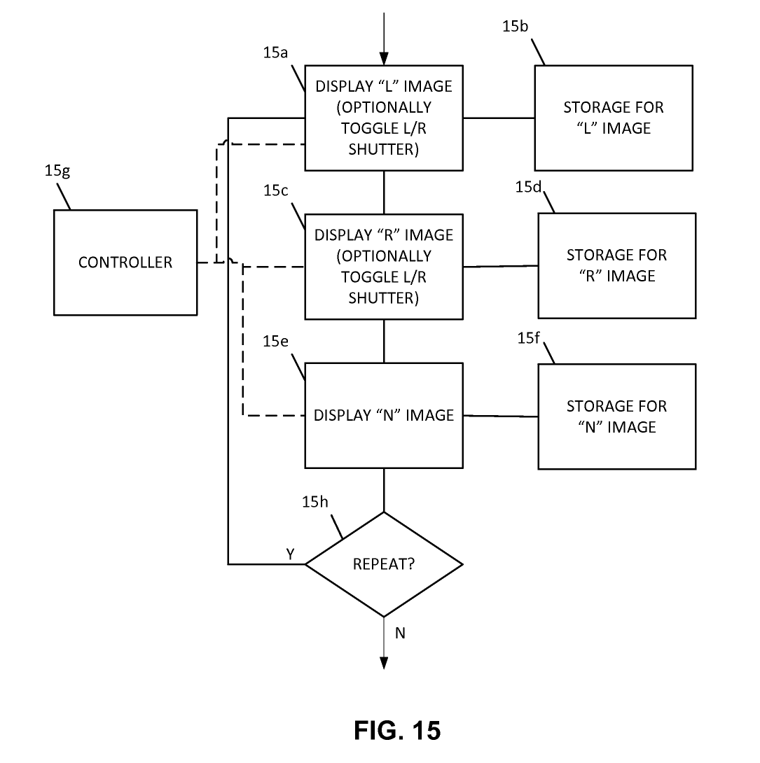

We will now describe illustrative embodiments of the present invention. First, we provide an introduction of the problem and our solution, and then a detailed description of illustrative embodiments of the inventive method and system. We will cover methods involving the implementation of a third channel, and brightness of the composite 2D image; experiments and our findings regarding 2D viewer preferences, 3D viewer depth perception, and moving 3D objects and the Pulfrich effect; a prototype system we developed; and a discussion of present limitations and future work to be done. We will also summarize some of the main aspects of our inventive system with reference to FIG. 15. Finally, a list of references is provided after the conclusion of the detailed description.

### A. INTRODUCTION

Stereoscopic displays provide a different image to the viewer's right and left eyes to produce a three-dimensional (3D) percept. These displays' falling prices have caused them to grow from a niche product to mass market acceptance with applications in entertainment, medical imaging, and engineering visualization.

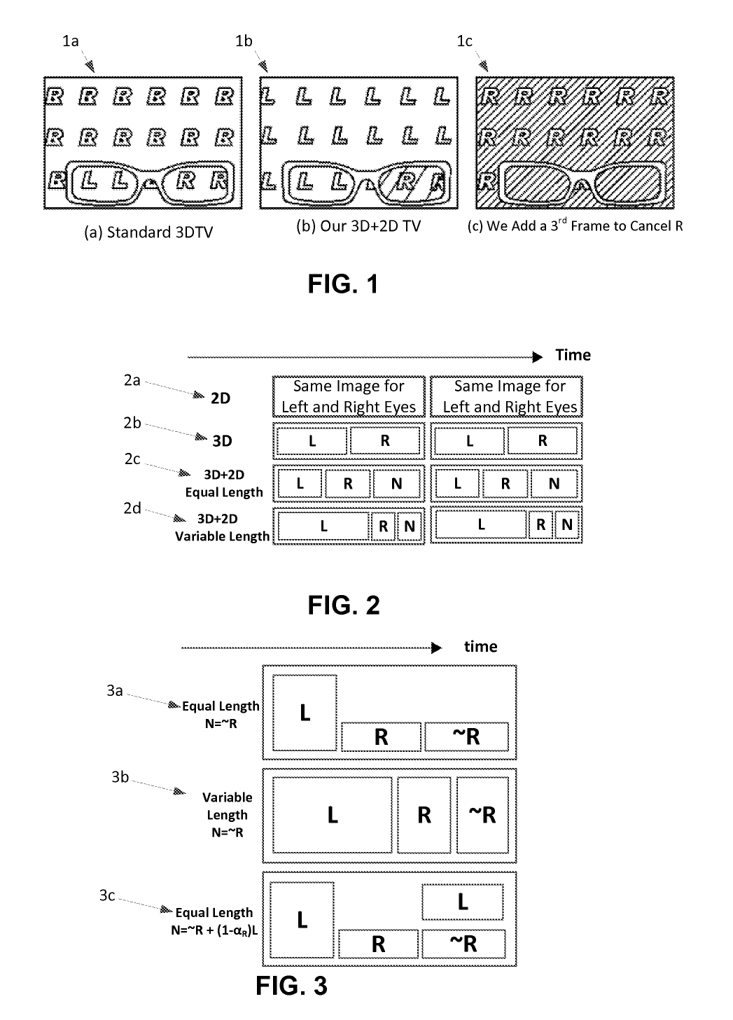

The following discussion makes reference to FIGS. 1 and 2 of the appended drawings, which depict the following:

FIG. 1 depicts images 1a, 1b and 1c., which may be summarized as follows: (a) A typical glasses-based 3DTV shows a different image to each eye of viewers wearing stereo glasses, visible through the glasses at the bottom of the figure, while those without glasses see both images superimposed, visible directly on the screen at the top of the figure. (b) Our 3D+2DTV likewise shows a different image to each eye of viewers wearing stereo glasses, but shows only one of these images to those without glasses, removing the “ghosted” double-image. (c) We accomplish this by displaying a 3rd image to those not wearing glasses that is not visible to those wearing glasses, cancelling out one image of the stereo pair.

FIG. 2: Here we compare various displays that show a sequence of frames. Reference numerals 2a, 2b, 2c and 2d represent the first, second, third and fourth rows, respectively, which depict the following: (1st row) A traditional 2D display shows a single image to both eyes. (2nd row) Each frame in a traditional active shutter glasses 3D display includes a distinct image for the Left (L) and Right (R) eyes of a viewer with glasses, while a viewer without glasses sees both images overlaid, with both eyes. (3rd & 4th rows) Our 3D+2D display adds a third image (N) to each frame, shown to neither eye of the viewer with glasses, but seen by both eyes of a viewer without glasses. This third image is used to display the negative of the Right image, leaving them a low-contrast version of the Left image. A 3D+2D display may display each image for an equal length of time or allot more time to the left image to improve contrast, shortening the R and N images accordingly.

The most popular 3D display paradigm shows a pair of images on the same screen, intended for the viewers' left and right eyes. The lenses of special shuttered or polarized “stereo glasses” pass images to the correct eye. A viewer not wearing these glasses sees both images superimposed, creating a “ghosted” double-image where two copies of objects appear overlaid (see FIG. 1a). It is not always desirable to require that all viewers wear stereo glasses. They can be prohibitively expensive, or may interfere with other activities. It would be preferable to allow those not wearing stereo glasses to see a single, unghosted view of the screen (see FIG. 1b).

We accomplish simultaneous viewing of 3D and 2D images by replacing the pair of images (Left, Right) with a triplet (Left, Right, Neither), where those wearing stereo glasses see the Neither image with neither eye; only those without stereo glasses can see it. The Neither image is the negative of the Right image (see FIG. 1c) so that they cancel when superimposed, leaving only the Left.

Unfortunately, this raises the minimum black level of the display for viewers without stereo glasses, drastically decreasing the contrast ratio. This can be mitigated by reducing the brightness of the Right image, αR, to αR≦100%, while maintaining the Left image at full brightness.

If this adjustment is small, the effect on the 3D experience of viewers with stereo glasses is negligible, but the increase in contrast ratio for viewers without glasses is also modest. If this reduction is larger, the improved contrast ratio for viewers without glasses will be significant, but if too large, the 3D experience of viewers with glasses will deteriorate. We conduct experiments identifying the acceptable range of aR for both viewers with and without glasses, and find that both are satisfied when 20%≦αR 69≦60%.

The left and right images may be given unequal brightness either by directly dimming one of the two images, or by adjusting the time allotted to each image, using variable-length frames. We analyze the contrast ratio achieved with each method in Section 3.2 below.

When viewers wearing stereo glasses see a brighter image with one eye than the other, they soon become accustomed to this and report an acceptable 3D experience. However, they also report that horizontally-moving objects appear at different depths than stationary or vertically-moving objects with the same disparity. This small, but measurable, phenomenon is known as the “Pulfrich Effect” and is similar to a time-delay of several milliseconds in their perception of the darker image.

We conduct experiments to quantify this effect. We also measure a similar depth-distortion caused by the 8 millisecond delay between the Left and Right images in a 120 Hz display. The distortion is small enough that it is typically ignored by 3D content creators. We show that these two effects cancel each other when one eye's brightness is 40% that of the other eye. In this regard depth perception is not diminished when one eye is dimmed, but instead is slightly improved.

A primary contribution of this invention is a simple method to allow simultaneous viewing of 3D content by viewers with glasses, and 2D content by viewers without. We support this contribution with experiments measuring: viewer preferences among 2D degradation options, viewer ability to perceive 3D when one eye is dimmed, and the magnitude of the Pulfrich Effect in this system. Lastly, we demonstrate a prototype system built using two commercial 3D projectors.

### B. RELATED WORK

Didyk et al. have also considered the problem of displaying a 3D image to a viewer wearing glasses while creating an acceptable 2D image for those without glasses, which they refer to as “Backward Compatible Stereo” (Didyk et al. 2011; Didyk et al. 2012). They reduce the disparity between objects in the left and right images to a minimal threshold, preferentially retaining high-frequency components. Smaller disparities make the 2D composite image more acceptable to viewers without glasses, but a ghost image remains.

Anaglyph stereo uses two color channels with passive glasses to provide different views to each eye, while sacrificing color fidelity and showing a double-image to viewers not wearing stereo glasses. The most common example uses red and cyan filters, but amber and blue filters have been used to reduce ghosting seen by viewers not wearing glasses (Sorensen 2004; Ramstad 2011).

Projection on an arbitrary textured object such as a brick wall is possible by adding a color cancelation term to the projected image (Grossberg et al. 2004; Grundhofer and Bimber 2008). We use the same principle, treating one of the stereo channels as a texture to be canceled.

The undesirable ghosting seen by viewers not wearing stereo glasses can also be avoided by using an autostereoscopic 3D display that does not require special glasses. Several techniques have been used to create such displays (Dodgson 2005). For example, a parallax barrier blocks light from reaching proscribed directions (Perlin et al. 2000), and a lenticular array bends light toward the desired direction (Matusik and Pfister 2004). Autostereoscopic displays are generally more complex than glasses-based 3D displays and therefore more expensive.

### C. METHODS

A typical 3D display produces two images for each frame, (Left, Right). A 3D+2D display produces three images for each frame, (Left, Right, Neither). Stereo glasses ensure that each eye of those wearing glasses sees only one of the three images, while viewers without glasses see the integral of all light. The third field is constructed to cancel one of the standard stereo fields.

A 3D+2D display is not restricted to a single stereo display technology. The key feature required is a third channel of information visible only to those not wearing glasses. In this section, we first discuss implementation options for an additional channel. We then discuss several options for the content of the third channel, which impacts the quality of the composite 2D image.

1. Implementing a Third Channel

Active-shutter displays show each image of the two-image frame packet sequentially, while the lenses of special stereo glasses become transparent or opaque in synchrony to block each eye from seeing images not intended for it. The temporal pattern can easily include more channels, to support our method, or uses such as additional stereo viewpoints (Agrawala et al. 1997) (McDowall et al. 2001). FIG. 2 illustrates possible temporal patterns supporting our method for both equal and variable length frames.

We believe our method will be most readily adopted by active shutter displays for three reasons. Firstly, it is easily implementable by manufacturers, requiring only a firmware change. Secondly, active-shutter glasses cost as much as ten times more than passive stereo glasses, costing $100 or more, so that owners of active shutter glasses are more hesitant to buy additional pairs of glasses. Thirdly, the Pulfrich effect removes a minor but undesirable depth distortion present in all active-shutter displays.

Two types of passive glasses have been used to create 3D displays. The most common glasses contain polarizing filters of orthogonal polarizations, while the display produces matching polarized images for each eye (Kim and Kim 2005). An alternate option uses lenses with spectral comb filters (Jorke and Fritz 2006). Each eye allows light in a non-overlapping narrow band of red, green, and blue wavelengths to pass. Passive stereo systems may produce the two images simultaneously with a pair of projectors, or on interleaved rows of a flat-screen display, or sequentially with a projector using a rotating filter wheel.

Implementing our method requires three channels instead of two. These could be provided by a single method, such as augmenting the spectral comb filters with a third set of narrow bands, or by combining methods, such as using polarization and spectral comb filters together to produce four orthogonal channels.

Our prototype implementation combines polarization with active shutter projectors to achieve the necessary three channels.

FIG. 3 illustrates how different amounts of wasted light result from different frame lengths for the L, R and inverse R frames. Reference numerals 3a, 3b and 3c represent the top, middle and bottom rows, respectively, which depict the following: (Top Row) When all three frames have Equal Length and N=^{˜}R, some available light is wasted. (Middle Row) Variable-Length Frames waste no light, improving contrast for 2D viewers. (Bottom Row) When using Equal-Length frames, the brightness for 2D viewers may be improved by setting N=^{˜}R+(1−αR)·L, wasting less light. For brevity we refer the inverse of R as: ^{˜}R=(αR·maxL−R).

2. Brightness of the Composite 2D Image

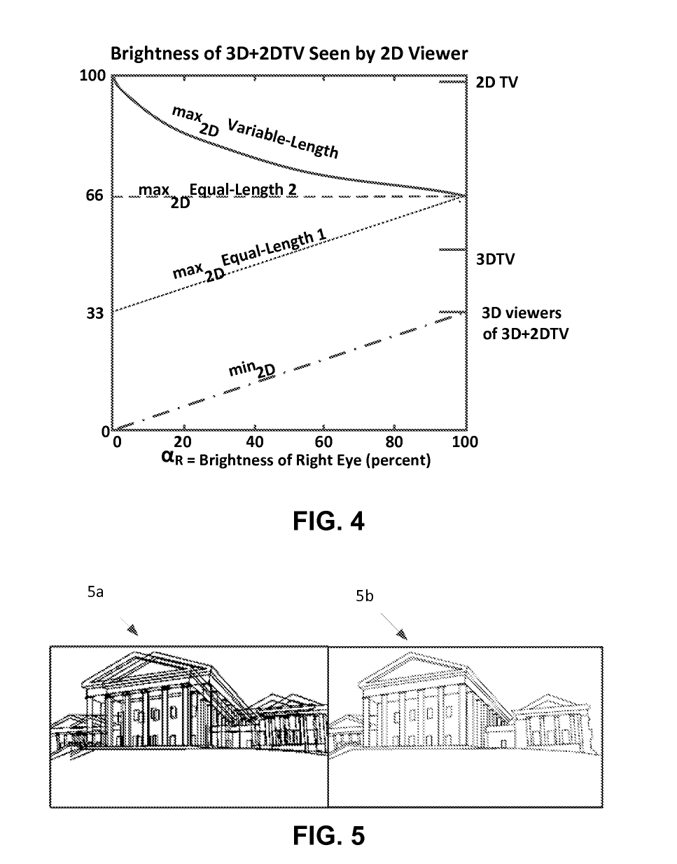

Our 3D+2D display shows three images each frame: L, R, and N. Viewers not wearing stereo glasses see only L, because N is chosen as the inverse of R such that N+R yields a uniform grey. The grey field raises the black level of the display: the brightness of the darkest pixel of the screen. If the three images are of equal brightness, the brightest pixel will be only twice as bright as the darkest pixel: a terrible contrast ratio. Allowing the L image to be brighter than the R and N images increases the contrast ratio. Several options are available to produce the N image, with different effects on contrast. We now analyze three possible options, depicted in FIG. 3, and their impact, quantified in FIG. 4.

Throughout, let L, R, and N be vectors of image pixels, containing all possible brightness values. Let the functions MAX(.) and MIN(.) find the maximum or minimum element in the vector. Let maxL=MAX(L) be the maximum possible brightness for any pixel in L, and similarly define maxR. Let αR=maxR/maxL 190≦100% refer to the brightness of the darker image R relative to L. Let max2D=MAX(L+R+N) be the brightness of the composite 2D image seen by viewers without glasses, and let its darkest possible pixel be min2D=MIN(L+R+N). Since N will be chosen to cancel out R, that is, R+N=maxR, we find that

min2D=MIN(R+N)=maxR=αR·maxL (1)

We now analyze how max2D varies with aR. First, in the simplest Equal-Length implementation of our technique, the three frames (L,R,N) are accorded equal time by the display. In this case, to darken the R and N images, aR is reduced but the brightness of the L image maxL remains unchanged. To cancel R with N, we constrain N to: R+N=maxR, trivially achieved by setting N=maxR−R=αR·maxL 203−R. Since the left frame is allotted one third of the display's photons, maxL=⅓, so the total brightness of the composite image is then:

$$\begin{matrix}max 2 DE 1 = MAX ( L + R + ( α R \cdot maxL - R ) ) \\ = maxL \cdot ( 1 + α R ) \\ = 1 \text{/} 3 + α R \text{/} 3\end{matrix} \qquad ( 2 )$$

Second, a Variable-Length display may instead dim the R and N images by affording them a smaller fraction of the total time in comparison to the L image. For example, plasma displays typically form each frame from many shorter microframes, which could be reapportioned unequally among the L, R, and N images. Similarly, some LCD displays now operate internally at very high frame rates of 240, 480, or 960 Hz, interpolating low-frame-rate content. These subframes could easily be deployed to give unequal time to the L image compared to the R and N images. In this case, darkening the R and N images allows a corresponding increase in the brightness of L. In order for N to cancel R, N and R are allotted equal time. Thus, while N=maxR−R, as before, maxL is now constrained as:

$$\begin{matrix}maxL = 1 - 2 \cdot maxR \\ = 1 - 2 \cdot α R \cdot maxL \\ = 1 / ( 1 + 2 \cdot α R )\end{matrix} \qquad$$

We thus find max2D in this case as:

$$\begin{matrix}max 2 DV = MAX ( ( 1 - 2 \cdot maxR ) + R + ( maxR - R ) ) \\ = 1 - maxR \\ = 1 - α R \cdot maxL \\ = 1 - α R \cdot 1 / ( 1 + 2 \cdot α R ) \\ = ( 1 + α R ) / ( 1 + 2 \cdot α R )\end{matrix} \qquad ( 3 )$$

Since αR≦1, the brightest pixel is brighter than in the previous case.

Third, the Equal-Length implementation may be improved. Observe that, as initially described, with αR<100% the N frame never shines with full brightness. Its unused brightness can be repurposed to duplicate L. Before, we had set N=(maxR−R)=(αR·maxL−R). Now, we add L in the unused portion of N:

N=(αR·maxL−R)+(1−αR)·L

With maxL=⅓ as before, the brightness of the composite image in this case is:

$$\begin{matrix}max 2 DE 2 = MAX ( L + R + ( α R \cdot maxL - R ) + ( 1 - α R ) \cdot L ) \\ = maxL + ( α R \cdot maxL ) + ( 1 - α R ) \cdot maxL \\ = 2 \cdot maxL \\ = 2 \text{/} 3\end{matrix} \qquad ( 4 )$$

This constant brightness falls roughly halfway between the two simpler implementations.

FIG. 4 is a graph showing how the brightness of the composite image seen by viewers not wearing stereo glasses improves when the brightness of the image shown to the right eye of 3D viewers is decreased. As shown, max2D, the brightness of the composite image seen by viewers not wearing stereo glasses improves when αR, the brightness of the image shown to the right eye of 3D viewers, is decreased. A display using variable-length frames can produce a brighter 2D image than one employing either Equal-Length technique. The brightness of the darkest pixel in the 2D composite image (min2D) is also lowered by darkening R. For comparison, we have also noted the brightness of a standard 2DTV, a standard 3DTV, and the 3D view of a 3D+2DTV.

Viewers wearing stereo glasses also experience lower brightness when this system is employed, because precious display time is devoted to emitting photons for viewers without glasses that never reach either eye of those wearing glasses. When using equal length frames, 3D viewers experience a brightness reduction of 33%. With variable length frames the maximum 3D brightness might increase or decrease depending on the choice of αR.

### D. EXPERIMENTS

The method introduced in this paper removes ghosting for 2D viewers at the cost of reducing contrast. Contrast can be improved by reducing brightness in one eye for 3D viewers, but this could impact 3D perception. We conducted an experiment to determine viewer preference for contrast versus ghosting, and two experiments to quantify the effect of reduced brightness on 3D perception of stationary objects. Finally, we quantified the Pulfrich effect's depth distortion of horizontally-moving objects.

1. 2D Viewer Preferences

Glasses-based stereoscopic displays superimpose images intended for the left and right eyes on the same space. Viewers wearing stereo glasses see only the appropriate image with each eye, but viewers without glasses see both images with both eyes, producing a double-image with a “ghosted” appearance. Our technique removes this ghosting, but also reduces the contrast. We conducted an experiment to determine at what level of contrast viewers prefer the original, ghosted image to a lower-contrast image without ghosting.

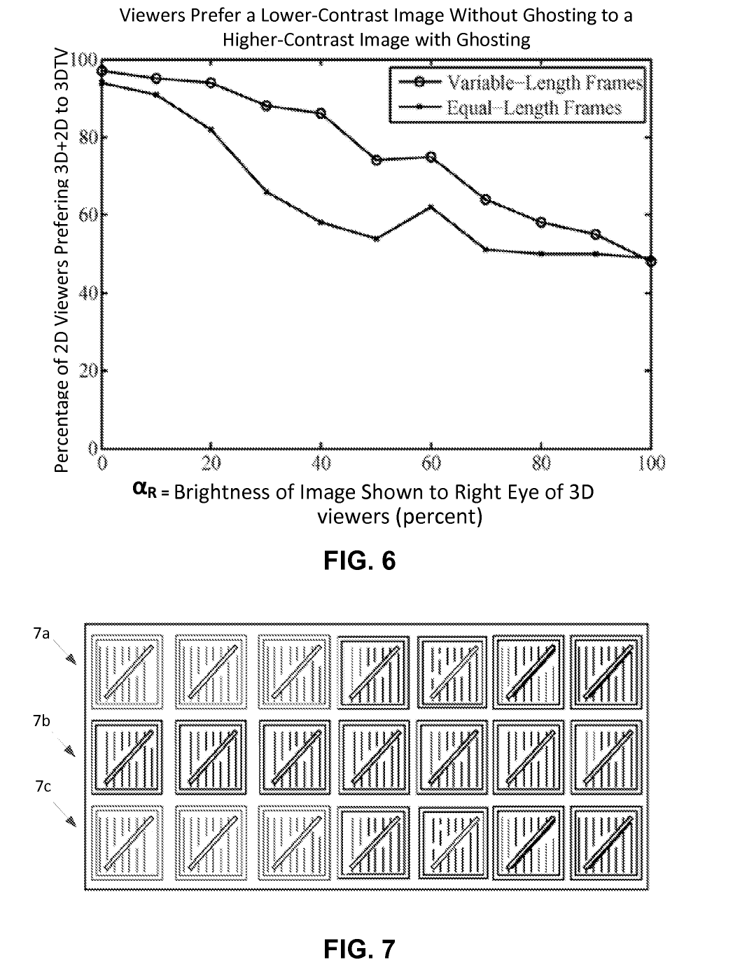

FIGS. 5 and 6 are referenced below. FIG. 5 depicts two versions of an image, 5a and 5b, and FIG. 6 is a graph of viewer preference data. We found that, as the brightness of one eye decreases, the contrast ratio increases, and a greater percentage of viewers prefer our display.

Specifically, in respect to FIG. 5, we showed viewers two versions of an image and asked which they prefer: (left, 5a) the ghosted double-image they would see on a typical 3D display if they did not wear stereo glasses, or (right, 5b) the lower-contrast image without ghosting that they would see on our display. In this example, αR=30%. On the left, 5a, we displayed the double-image L+R seen on a traditional active-shutter stereoscopic display; and on the right 5b, we displayed L+R+N in accordance with the analysis of the previous section. In respect to FIG. 6, we asked subjects to choose between the image they would see without glasses on a traditional 3DTV and on our display. Note that our display is preferred by a majority of users.

We conducted experiments simulating simple Equal-Length frames (FIG. 3(top 3a)) and Variable-Length frames (FIG. 3(middle 3b)). Ten subjects participated in each experiment. Subjects' responses were averaged across ten test images, each judged at eleven values of αR. We found that at high contrast levels viewers nearly uniformly prefer our method. Only at very low 2:1 contrast do viewers find contrast reduction equally objectionable as ghosting (FIG. 6). For a display with αR=20% and equal-length frames, 80% of our subjects prefer low-contrast images without ghosting. A display capable of producing variable-length frames is able to provide a higher contrast for the same value of αR. With this design the preference for our system rises to 95%.

2. 3D Viewer Depth Perception

We display a brighter image to 3D viewers' left eyes than to their right eyes. A modest difference in brightness may be imperceptible, but a completely black right-eye image will obviously preclude stereoscopic vision. We conducted two experiments to quantify depth perception between these two extremes.

We presented subjects, wearing 120 Hz shutter glasses and viewing a 42″ plasma 3DTV, with a stereoscopic display of a 7×3 array of wooden boxes, as in FIG. 7. The top and bottom rows were identical and unchanged throughout the experiment, with each box in the row at a different depth, in the range of (−6,6) pixels disparity. The middle row of boxes were all at the same depth; this depth was varied in each trial. Subjects were asked to identify which column of the top-and-bottom-row boxes was at the same depth as the boxes in the middle row. They answered e.g. “The boxes in the middle row are at the same depth as the top and bottom boxes in column three.”

Six subjects participated in the experiment. Each subject made a total of 130 judgments, across 5 different brightness levels and 13 possible depths.

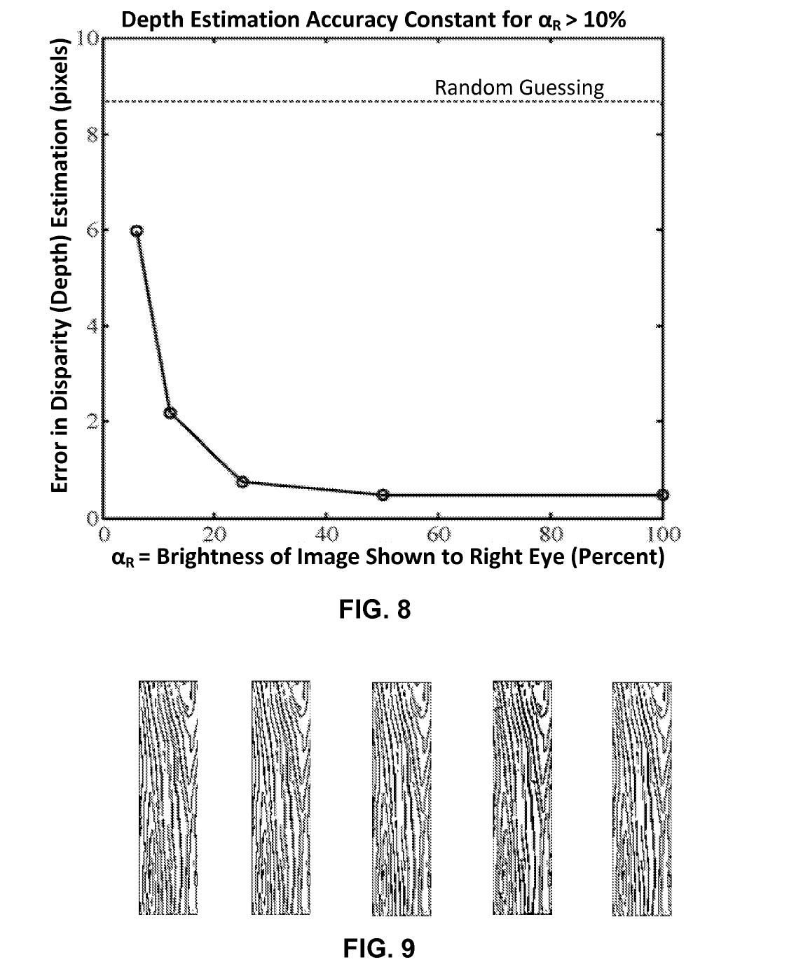

We find that depth perception is surprisingly robust against differences in image brightness between the two eyes, and is not significantly affected until αR falls below 20% (FIG. 8).

In a second experiment, we showed subjects a set of five vertical sticks, as seen in FIG. 9, while again the brightness of the image seen by their left and right eyes differed. One of the three central sticks was displayed with a different disparity than the other 4 sticks, so that it was perceived as lying at a different depth. The subject was asked to identify which stick was at a different depth than the other sticks. 15 subjects participated in the experiment. Each subject made judgments with αR varied to 27 levels. On each individual trial depths were chosen randomly in the range of (1,7) pixels of disparity.

Viewer ability to perceive depth differences was not impaired until the brightness of the darker eye became very dark, similarly to the previous experiment. Accuracy fell slowly from the equal brightness case until αR fell below 10%. When αR<10%, subjects answered as if guessing randomly.

FIGS. 7-9 may be summarized as follows:

FIG. 7: This experiment quantified viewers ability to perceive depth in static images on a stereoscopic display when one eye is presented with a darker image than the other eye. The subject was shown 3 rows of boxes, 7a, 7b, 7c, reproduced here in anaglyph format for illustrative purposes. The top row 7a and bottom row 7c are identical to each other, featuring 7 boxes with progressively different disparities. In the top and bottom row, the left-most box appears furthest away and the right-most box appears closest. The middle row 7b contains 7 boxes, all shown with the same disparity. The subject was asked which box in the top and bottom rows is at the same depth as the boxes in the middle row. The disparity of the boxes in the middle row was varied randomly in each trial.

FIG. 8 shows the results of the experiment seen in FIG. 7. As one eye's brightness decreases, viewers' ability to perceive depth is not affected until the brightness of the darker eye is below 20% of the brightness of the brighter eye.

FIG. 9: This experiment measured viewers' ability to perceive depth when the images shown to one eye are darker than those shown to the other eye. The subjects viewed five sticks, where one was displayed at a different disparity than the other four, as seen in this screen shot, converted to anaglyph form.

3. Moving 3D Objects and the Pulfrich Effect

Presenting left and right eyes with unequal brightness has a different effect on moving objects than it does on stationary objects. Accurate depths are reported for stationary objects and those moving vertically, but the depths for objects moving horizontally show a predictable distortion, known as the Pulfrich effect (Pulfrich 1922; Morgan and Thompson 1975). The effect has been used to produce 3D effects in commercial television by distributing tens of millions of paper glasses that feature one dark lens. We conducted an experiment to measure its impact on our system.

We find a small but measurable distortion in the depth of horizontally moving objects, and that this effect can be used to counter another distortion present in sequential-frame 3D displays.

We showed 331 subjects a 3D scene containing two rows of seven stationary boxes, as in the first experiment of section 4.2. The boxes appear to sit at different depths, with the left-most pair of boxes the furthest away, and the right-most pair closest. A moving box repeatedly passed horizontally between the two rows of stationary boxes, as in FIG. (11).

The subjects were asked to identify the stationary box whose depth most closely matched the depth of the moving box. The stationary boxes were unaltered throughout the experiment, but the moving box's speed, direction, and disparity (true depth) were randomly varied. Due to the depth distortions of the Pulfrich Effect, the subjects estimated a consistently different depth for the moving object, depending on its speed and the brightness of each eye.

Three subjects participated in this experiment. Each subject viewed 42 presentations of the scene at each of nine levels of a, with the box moving in a random direction (left or right) at one of seven speeds and at one of three depths (0, 6, or 12 pixels disparity). This experiment was initially conducted with the images shown to both eyes having the same brightness, and was repeated with the left or right eye dimmed relative to the other eye.

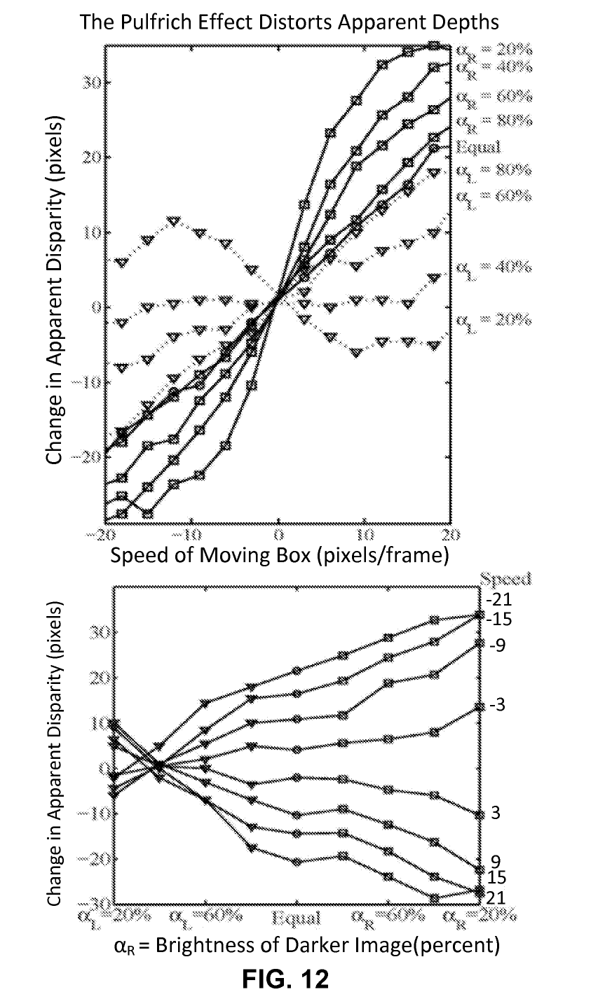

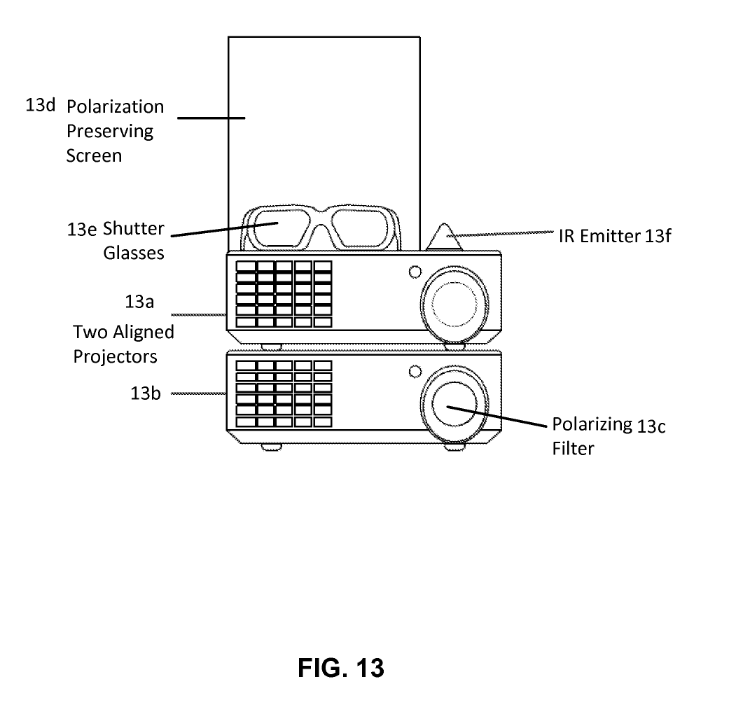

FIG. 12 provides two plots visualizing the same data projected in different ways. In the upper plot the x-axis represents the speed of the moving object, with each curve corresponding to brightness difference between the right and left eyes. In the lower plot the x-axis represents the brightness difference, with each curve corresponding to speed of moving object. In both cases the vertical axis shows the difference between the reported depth and the actual depth of the moving object.

Notice that the reported depth error is closest to zero when the left eye is dimmed significantly, rather than when both eyes have equal brightness.

This can be explained by another distortion inherent in shuttered displays. In the upper plot, the blue line corresponds to images of equal brightness shown to both eyes, and is not a horizontal line with no error. This is caused by the sequential nature of active-shutter 3D displays. In a 120 Hz-capable display that shows (left, right) image pairs at 60 Hz, the image shown to the right eye will always lag behind the image shown to the left eye (or vice versa) by 1/120th of a second (8 milliseconds). This time delay causes a speed-dependent distortion in the apparent depth of objects (Dvorak 1872). This depth distortion is often ignored by 3D content creators, e.g. many cameras, the Blu-ray 3D specification, and Nvidia all treat the left and right frames as simultaneous (Vetro et al. 2011) (Gateau and Neuman 2010).

The Pulfrich Effect can be roughly modeled as a time-delay experienced by the dimmer eye. Thus when the left eye is dimmed to approximately 40% the brightness of the right eye, the speed dependent depth-distortion caused by the Pulfrich Effect largely cancels out the distortions caused by the sequential display of left and right stereo images. In the lower plot, we can see that it is not necessary to choose precisely αL=40%. Any darkening of the left eye will lower the error inherent in existing displays.

For consistency of notation and labeling in this application we continue to refer to the right eye as the one that is darkened. However, real implementations on sequential-frame displays should darken the eye presented first.

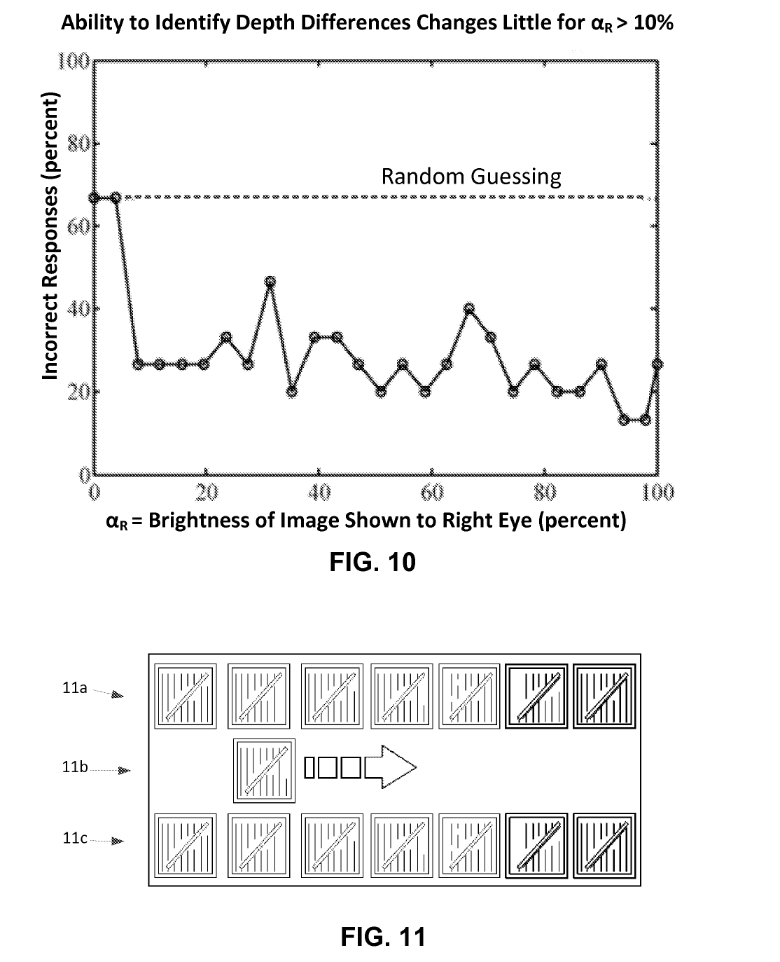

FIGS. 10-12 may be summarized as follows:

FIG. 10: In the experiment seen in FIG. 9, viewers' ability to perceive depth differences was undisturbed by one eye seeing a darker image than the other, provided the dark image was at least 10% as bright as the brighter eye.

FIG. 11: We conducted an experiment to quantify the impact of the Pulfrich Effect on depth perception. We showed subjects a scene consisting of two identical rows of seven boxes. The boxes varied in disparity, with the left-most boxes appearing further away and the right-most boxes appearing closest to the viewer. A moving box passed between the two rows, and the subject was asked to choose which stationary box was at the same depth as the moving box.

FIG. 12: When one eye is brighter than the other, the depth of moving objects is misperceived. Faster objects have a greater distortion in their apparent depth. A larger difference between the brightness of the two eyes also causes a greater distortion in the perceived depth. These two plots visualize the same data in different ways to elucidate different aspects of the phenomenon. (Top) The distortion is close to linear for speeds under 10 pixels/frame and in this regime is well-modeled as an induced time delay in the image stream presented to the darker eye. (Bottom) Note that objects at all speed are distortion free near αL=40% and not at α=100%.

### E. PROTOTYPE

We have built a prototype of the system using two projectors and a single polarization-preserving screen. The first projector is a standard 3D (120 Hz) projector synced to Nvidia LCD active-shutter glasses and is not polarized. This projector displays the images L and R seen by the left and right eyes of the viewer wearing glasses. The second projector displays the 3rd image, and is linearly polarized. The LCD active-shutter glasses contain an orthogonal linear polarizing element, so that the image from the second projector is not visible. FIG. 13 shows these components.

Note that the first projector spends half its light on the L frame and half on the R frame. The second projector spends all its light on the N frame, but half of this light is lost to the linear polarizer. This leaves all three frames with approximately the same brightness. Geometric and photometric calibration are performed to align the images and correct non-linearities in the projected brightness (Brown et al. 2005).

In the prototype of FIG. 13, an unpolarized 3D projector synchronized with active-shutter LCD 3D glasses shows the L and R images. A second, linearly polarized projector shows the N image. LCD shutter glasses contain a linear polarizing filter that blocks the light from the polarized projector.

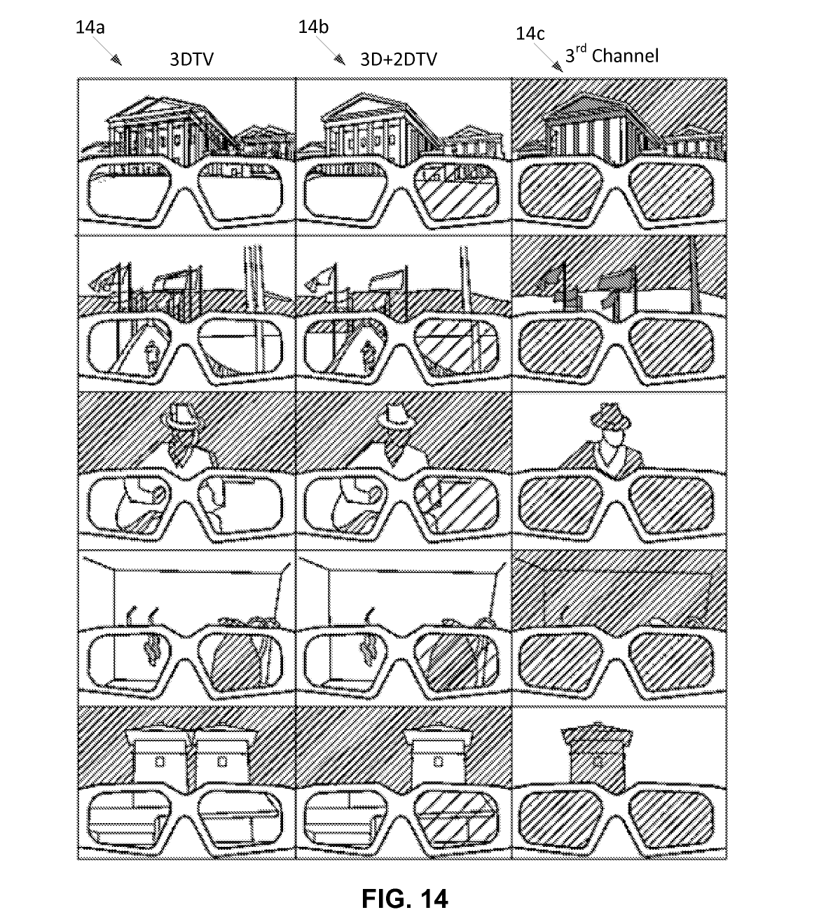

We evaluated our system by displaying images in standard 3D, as well as using our 3D+2D method. FIG. 14 shows a number of examples, together with the third channel that we introduced. (In each image, the projector screen is visible directly at the top of the image, and through each lens of the stereo glasses at the bottom of the image. (Left Column) A typical 3D display (Middle Column) our 3D+2D prototype, with αR=30% (Right Column) the 3rd channel we display to cancel out the right-eye image.) The example images were captured using a camera pointed at the projection screen. A set of shutter glasses reveals the images delivered to the left and right eyes of 3D viewers, while the region outside the glasses shows the experience of viewers without glasses. In our implementation, only very minor ghosting is visible in the 2D region, and the third channel is blocked by the shutter glasses.

### F. LIMITATIONS AND FUTURE WORK

Our prototype uses a low quality screen with a significant specular reflection. As a result, our radiometric calibration is only approximate, and ghosting has not been completely eliminated. The screen's preservation of polarization is also imperfect, so that the N image is slightly visible through stereo glasses. Higher quality components and calibration would rectify these issues.

This work has focused on completely eliminating ghosting, and we have compared 2D viewer preferences regarding ghosting and contrast under this assumption. However we have noticed that when the ghost is relatively dim, it is not as objectionable. Further study might reveal an optimum tradeoff between ghosting and contrast reduction by only partially cancelling the ghost image.

In all cases we have analyzed brightness using physical values. However we have observed that when one eye is much brighter than the other, the perceptual brightness is closer to that of the brighter eye. A more careful investigation of perceptual brightness could improve our conclusions about observed brightness when each eye sees an image of different brightness.

### G. 3D+2DTV SYSTEM

Turning now to FIG. 15, the illustrative embodiments described above may be summarized as follows. A left (“L”) image or sub-image is displayed for a first period of time. This is shown in block 15a. The “L” image is obtained from storage 15b. The display of the “L” image may optionally be coordinated with the toggling of a shutter, e.g., in the right lens of 3D eyeglasses being worn by a viewer. In other words, if a viewer is wearing shutter eyeglasses, these may be controlled to prevent the “L” image from being viewed in the right eye of the viewer.

Next, a right (“R”) image is displayed for a second period of time, as represented by block 15c. As shown, the “R” image is obtained from storage 15d. As with the “L” image, the display of the “R” image may be coordinated with the toggling of a shutter covering the left eye of the viewer.

The display of the “R” image is followed by the display of the “N” image, for a selected period of time, as shown in block 15e. The “N” image is obtained from storage 15f. As discussed above, this step is designed to substantially cancel out the perception of the “R” image for viewers not wearing 3D eyeglasses, to mitigate ghosting for viewers not wearing 3D eyeglasses. If additional images are to be displayed, as indicated in decision block 15h, the process is repeated. These steps are controlled by a controller 15g, which may be a programmed microprocessor or the like.

As discussed above, the inventive method will likely be more readily adopted by active shutter displays, i.e., since it can be implemented by manufacturers at low cost, allows consumers to avoid purchasing additional pairs of active-shutter glasses, and removes a minor but undesirable depth distortion present in active-shutter displays. Moreover, the inventive method employs three channels (“L”, “R”, “N”), which could be provided by a single method, such as augmenting a pair of spectral comb filters with a third set of narrow bands, or by combining methods, such as using polarization and spectral comb filters together to produce four orthogonal channels. (The prototype implementation described above combines polarization with active shutter projectors to achieve the necessary three channels.) Finally, as explained above, the frame lengths for the “L”, “R” and inverse R frames may be adjusted to optimize the viewers' experience.

### H. CONCLUSION

3D display technology is quickly growing in popularity. Many current displays require that viewers wishing to see the 3D scene wear special glasses; viewers without glasses not only do not see a 3D scene, but see an unappealing double-image.

We have demonstrated a method to produce 3D displays where viewers wearing glasses see a 3D scene, while those without glasses see a single 2D scene. We have shown that reducing the brightness of one of the images shown to the 3D viewer does not interfere with depth perception, while allowing improved contrast for the 2D viewer. We have also demonstrated that existing depth-distortions in active-shutter displays can be eliminated, due to the Pulfrich effect induced when one eye has reduced brightness.

The true scope of the present invention is not limited to the presently preferred embodiments disclosed herein. For example, the foregoing disclosure of methods and systems for use in making a 3D+2DTV system uses explanatory terms, such as 3DTV, 2DTV, and the like, which should not be construed so as to limit the scope of protection of the following claims, or to otherwise imply that the inventive aspects of the disclosed system are limited to the particular methods and apparatus disclosed. Accordingly, except as they may be expressly so limited, the scope of protection of the following claims is not intended to be limited to the specific embodiments described above.

### I. REFERENCES

The following documents are referenced in the foregoing description. These are generally available and copies will be placed in the USPTO file for the present application:
AGRAWALA, M., BEERS, A. C., MCDOWALL, I., FROHLICH, B., BOLAS, M., AND HANRAHAN, P. 1997. The two-user responsive workbench: support for collaboration through individual views of a shared space. In Proceedings of SIGGRAPH 1997, ACM Press/Addison-Wesley Publishing Co., Annual Conference Series, 327-332.
BROWN, M., MAJUMDER, A., AND YANG, R. 2005. Camera based calibration techniques for seamless multiprojector displays. IEEE Transactions on Visualization and Computer Graphics 11, 2, 193-206.
DIDYK, P., RITSCHEL, T., EISEMANN, E., MYSZKOWSKI, K., AND SEIDEL, H.-P. 2011. A perceptual model for disparity. ACM Transactions on Graphics 30, 4 (August), 96:1-96:10.
DIDYK, P., RITSCHEL, T., EISEMANN, E., MYSZKOWSKI, K., AND SEIDEL, H.-P. 2012. Apparent stereo: The cornsweet illusion can enhance perceived depth. In Human Vision and Electronic Imaging XVII, IS&T/SPIE's Symposium on Electronic Imaging, 1-12.
DODGSON, N. 2005. Autostereoscopic 3d displays. IEEE Computer 38, 31-36.
DVORAK, V. 1872. ber analoga der personlichen differenz zwischen beiden augen and den netzhautstellen desselben auges. Prag: Sitzber. d. k. bhm. Gesellsch. d. Wiss, 6574.
GATEAU, S., AND NEUMAN, R. 2010. Stereoscopy, from xy to z. Short Course Siggraph Asia 2010.
GROSSBERG, M., PERI, H., NAYAR, S., AND BELHUMEUR, P. 2004. Making one object look like another: Controlling appearance using a projector-camera system. IEEE Conference on Computer Vision and Pattern Recognition (CVPR).
GRUNDHOFER, A., AND BIMBER, O. 2008. Real-time adaptive radiometric compensation. IEEE Transactions on Visualization and Computer Graphics 14, 1, 97-108.
JORKE, H., AND FRITZ, M. 2006. Stereo projection using interference filters. In Society of Photo-Optical Instrumentation Engineers (SPIE) Conference Series.
KIM, S.-C., AND KIM, E.-S. 2005. A new liquid crystal display based polarized stereoscopic projection method with improved light efficiency. Optics Communications 249, 1-3, 51-63.
MATUSIK, W., AND PFISTER, H. 2004. 3d tv: a scalable system for real-time acquisition, transmission, and autostereoscopic display of dynamic scenes. ACM Transactions on Graphics 23, 3 (August), 814-824.
MCDOWALL, I. E., BOLAS, M. T., CORR, D., AND SCHMIDT, T. C. 2001. Single and multiple viewer stereo with dlp projectors. Proc. SPIE 4297.
MORGAN, M., AND THOMPSON, P. 1975. Apparent motion and the pulfrich effect. Perception 4, 1, 3-18.
PERLIN, K., PAXIA, S., AND KOLLIN, J. S. 2000. An autostereoscopic display. In Proceedings of SIGGRAPH 2000, ACM Press/Addison-Wesley Publishing Co., Annual Conference Series, 319-326.
PULFRICH, C. 1922. Die stereoskopie im dienste der isochromen and heterochromen photometrie. Die Naturwissenschaften.
RAMSTAD, MONTE, J., 2011. Patent WO 2011031326. Interference filters for viewing anaglyphs.
SORENSEN, SVEND ERIK BORRE, H. P. S. S. N. L., 2004. U.S. Pat. No. 6,687,003. Method for recording and viewing stereoscopic images in color using multichrome filters.
VETRO, B. A., WIEGAND, T., AND SULLIVAN, G. J. 2011. Overview of the stereo and multiview video coding extensions of the h. 264/mpeg-4 avc standard. Proceedings of the IEEE 507 99, 4, 626-642.

1. A method for displaying an image on a 3D+2D television, comprising:
displaying (15a) a left (“L”) image for a first period of time;
displaying (15c) a right (“R”) image for a second period of time; and
displaying (15e) a third, inverse image (“N”) for a selected period of time, wherein the display of the inverse image “N” substantially cancels out the perception of one of the “L” image and the “R” image for viewers not wearing 3D eyeglasses.

2. A method as recited in claim 1, wherein the method is effective to mitigate ghosting for viewers not wearing 3D eyeglasses.

3. A method as recited in claim 1 or 2, wherein additional images are displayed by repeating the steps of claim 1.

4. A method as recited in any of the preceding claims, wherein the steps are controlled by a controller (15g).

5. A method as recited in any of the preceding claims, wherein the method is performed using an active shutter display.

6. A method as recited in any of the preceding claims, wherein the method is performed using a pair of spectral comb filters augmented with a third set of narrow bands.

7. A method as recited in any of the preceding claims, wherein the method is performed using polarization and spectral comb filters together to produce at least three orthogonal channels.

8. A method as recited in any of the preceding claims, wherein the frame lengths for the “L”, “R” and inverse frames “N” are adjusted to optimize a viewer's experience.

9. A method as recited in any of the preceding claims, wherein the “L” image is obtained from storage (15b).

10. A method as recited in any of the preceding claims, wherein the display of the “L” image is coordinated with the toggling of a shutter in the right lens of 3D eyeglasses being worn by a viewer.

11. A method as recited in any of the preceding claims, wherein the “R” image is obtained from storage (15d).

12. A method as recited in any of the preceding claims, wherein the display of the “R” image is coordinated with the toggling of a shutter covering the left eye of a viewer.

13. A method as recited in any of the preceding claims, wherein the “N” image is obtained from storage (15f).

14. A method as recited in any of the preceding claims, wherein the display of the “N” image substantially cancels out the perception of the “R” image for viewers not wearing 3D eyeglasses.

15. A 3D+2D television system, comprising:
a display device (13d) configured for viewing by one or more viewers;
a pair of 3D eyeglasses (13e) that can optionally be worn by a viewer;
means (13a) for alternately displaying a left (“L”) image for a first period of time and for displaying a right (“R”) image for a second period of time; and
means (13b, 13c) for displaying a third, inverse image (“N”) for a selected period of time, wherein the display of the inverse image “N” substantially cancels out the perception of one of the “L” image and the “R” image for viewers not wearing 3D eyeglasses.

16. A 3D+2D television system as recited in claim 15, wherein the operation of the system is effective to mitigate ghosting for viewers not wearing 3D eyeglasses.

17. A 3D+2D television system as recited in claim 15, further comprising a controller (15g) for controlling the display of the “L”, “R” and “N” images.

18. A 3D+2D television system as recited in claim 15, wherein the 3D eyeglasses include an active shutter.

19. A 3D+2D television system as recited in claim 15, further comprising polarization and spectral comb filters configured to produce at least three orthogonal channels.

20. A 3D+2D television system as recited in claim 15, wherein the frame lengths for the “L”, “R” and inverse frames “N” are adjusted to optimize a viewer's experience.
